(19) United States
(12) Patent Application Publication
(10) Pub. No.: US 2004/0152448 A1
(43) Pub. Date: Aug. 5, 2004

(54) Method and arrangement for authenticating terminal equipment

(75) Inventor: Jussi Passi, Oulu (FI)

Correspondence Address: Crawford Maunu PLLC, 1270 Northland Drive, Suite 390, St. Paul, MN, 55120, US

(73) Assignee: Nokia Corporation

(21) Appl. No.: 10/738,567

(22) Filed: Dec. 17, 2003

(30) Foreign Application Priority Data
Dec. 20, 2002 (FI) 20022256

(51) Int. Cl. H04M 1/66

(52) U.S. Cl. 455/411

(57) ABSTRACT

An arrangement and method for authenticating terminal equipment establishing a connection to a system. An authentication server receives an authentication request concerning the terminal equipment establishing the connection and comprising a user ID, the authentication server determines on the basis of the user ID the system to which the terminal equipment is trying to connect. The authentication server transmits the authentication request to an identification server of said system. The terminal equipment transmitting the request is authenticated in the identification server of the system and a response is transmitted to the authentication server. The establishment of a connection between the system and the terminal equipment is approved or refused on the basis of the response.

### FIELD

The invention relates to authentication during connection establishment. In particular, the invention relates to a system in which devices transmit connection requests to obtain a connection to a desired system.

### BACKGROUND

Many telecommunications applications want to identify the users of a provided service or application. This is especially true to applications in which at least part of a telecommunications connection is through a public telecommunications network. In a company, internal data connections can for instance be implemented in such a manner that some of the devices requiring a connection are not inside the company premises and to establish the connection, part of the connection uses the network of a telephone network operator or the like. Remote devices can set up a connection to the internal system of the company through a specific network access server NAS. The connection can be set up by means of a modem bank, in the case of a GSM network or fixed landline, or a GPRS gateway support node GGSN, in the case of a GPRS network. When these are used, it is thus necessary to perform authentication, i.e. identify the device requesting a connection and make sure that it is entitled to connect to the system.

Known solutions, when using a modem bank or GGSN, utilize a RADIUS server for user authentication. The RADIUS server is a server, typically a computer, that communicates with NAS by using the known RADIUS (Remote Authentication Dial In User Service) protocol. The protocol is defined in the Internet standard RFC 2865. In known solutions, the RADIUS server reads authentication information from its own local memory or from a local server and makes an authentication decision, i.e. a decision on whether a connection is set up and the terminal requesting the connection is allowed into the network.

One drawback with the prior-art solutions is that the authentication information must be stored so that it is available to the RADIUS server. This is especially difficult when the connection is set up using a telecommunications system operator that is typically not the system with which the terminal actually wants to establish the connection. Thus, the telecommunications operator must have a specific database on the terminals and/or users of different systems. Another problem arises from the fact that the systems must inform the operator concerning possible changes in the user database.

The standard RFC 2865 enables the RADIUS server to act as a cache server, but in this solution, the server transmits authentication requests between the servers of two operators and, therefore, this is not a solution to the above-mentioned drawback.

### BRIEF DESCRIPTION

It is an object of the invention to implement an improved method and arrangement for authenticating terminal equipment. As one aspect of the invention, an arrangement for authenticating terminal equipment is presented, the arrangement comprising an authentication server that is arranged to receive an authentication request concerning a terminal establishing a connection and comprising a user ID, and to identify on the basis of the user ID the system, to which the terminal is trying to connect. The authentication server is arranged to transmit the authentication request to the identification server of said system, and the identification server of the system is arranged to authenticate the terminal which transmitted the request and to send a response to the authentication server that is arranged, on the basis of the response, to either approve or refuse the establishment of a connection between the system and terminal.

As a second aspect of the invention, a method for authenticating terminal equipment establishing a connection to a system, the method comprising receiving at an authentication server an authentication request concerning the terminal establishing the connection and comprising a user ID, determining at the authentication server on the basis of the user ID the system, to which the terminal is trying to connect, transmitting from the authentication server the authentication request to the identification server of said system, authenticating the terminal sending the request in the identification server of the system, and sending a response to the authentication server, approving or refusing, on the basis of the response, the establishment of a connection between the system and terminal.

In some embodiments, the authentication server of the operator, which is typically a RADIUS server or a server using another corresponding authentication protocol, identifies from the authentication request the system with which a connection is requested, and transmits the request to the server of said system for the actual authentication.

The method and arrangement of the preferred embodiments of the invention provide several advantages. The operator maintaining the modem bank or GGSN needs no longer maintain user information on its own server. Updating the user information can easily take place in the databases of the systems, and possible changes need not be informed to the operator. The operator can serve several different systems and since the user information of the systems is only inside the systems, data security is better than before.

### LIST OF FIGURES

The invention will now be described in greater detail by means of preferred embodiments and with reference to the attached drawings, in which

FIG. 1 is an example of an arrangement of one embodiment,

FIG. 2 is a signal diagram of an embodiment, and

FIG. 3 is a flow chart of an embodiment.

### DESCRIPTION OF EMBODIMENTS

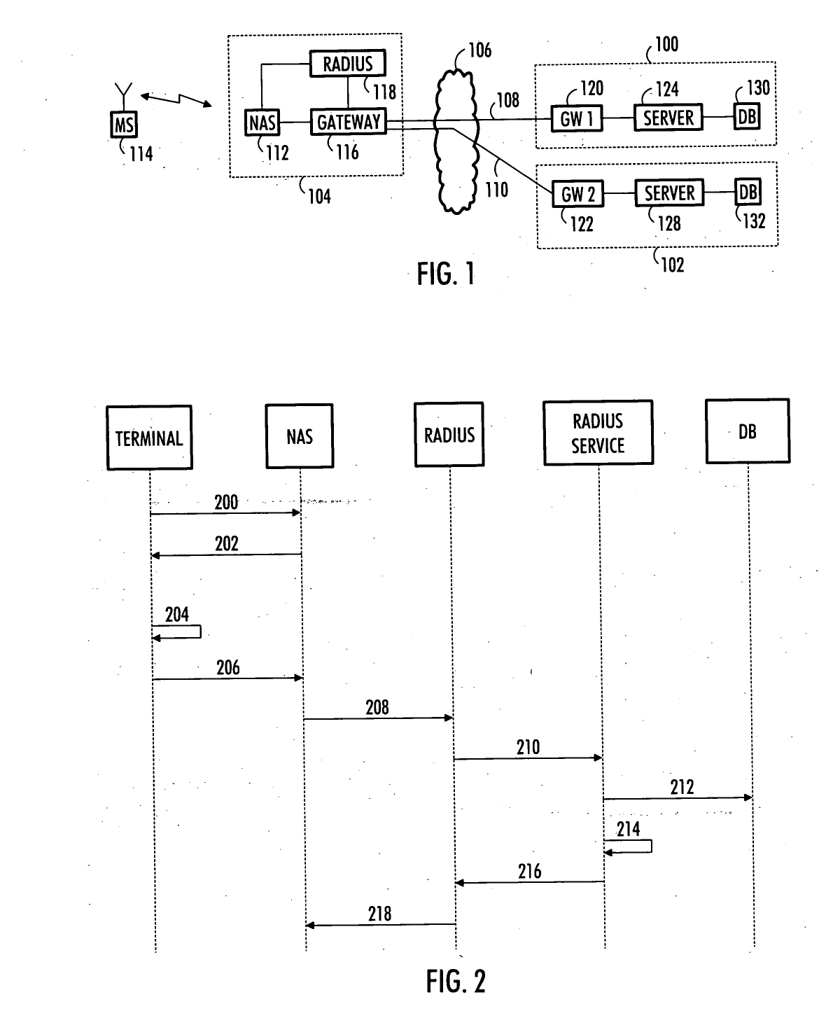

An example of an arrangement according to one embodiment is examined with reference to FIG. 1. FIG. 1 shows two systems 100, 102, which remote users or terminals can connect to through a telecommunications network 104. The telecommunications network 104 is connected to the systems 100, 102 for instance through the Internet 106 over secure connections 108, 110. In this context, secure connections refer to connections using a known ciphering or encryption method.

The telecommunications network 104 comprises one or more network access servers NAS 112 that can be implemented in different ways. A network access server can be a modem bank, for instance, which terminals can call. A network access server can also be implemented by means of a GPRS gateway support node GGSN. This is the case, if the network is a GPRS (General Packet Radio Service) network.

The terminal 114 connecting to the system 100 or 102 can be a device behind a wireless connection, such as a mobile phone as in FIG. 1, or a device on a landline and connecting to the network by calling a modem bank. The terminal can also be a terminal without a display or keyboard and integrated to another device that requires telecommunications services. These include elevators or various automatic machines.

The network 104 comprises a gateway 116 connected operatively to the network access server and an authentication server 118. The gateway directs traffic outside the network through the Internet 106, for instance. In one preferred embodiment of the invention, the authentication server is a RADIUS server. The authentication server 118 can naturally be integrated to the gateway 116.

The systems 100, 102 typically have each their own gateway 120, 122 that is responsible for the connections to the Internet 106, for instance. The servers in the system, such as identification servers 124, 128 that are arranged to identify the terminals requesting access to the system, are connected to the gateway through the system network. The identification servers can be connected to a database or user register 130, 132 that comprises user IDs and the necessary information on the users of the system. The identification servers 124, 128 and the databases 130, 132 can naturally also be integrated to the gateways 120, 122.

Let us next examine an example of an embodiment by means of FIG. 1 and the signal diagram of FIG. 2. The terminal 114 transmits a connection message 200 to NAS 112. From the message, NAS detects that the requested connection requires authentication. NAS then generates a random challenge according to the RFC 2865 standard and transmits 202 it to the terminal. The terminal generates 204 a response to the challenge by encrypting the challenge with its own password and transmits 206 the response, its user ID and user identification to NAS. The user ID and user identification are according to CHAP (Challenge-Handshake Authentication Protocol).

After this, NAS 112 transmits an authentication request 208 to the RADIUS server 118 requesting permission for setting up a connection. NAS can communicate directly with the RADIUS server without the gateway. The authentication request transmitted by NAS comprises the challenge generated for the terminal, the response of the terminal to the challenge, the user ID and identification for the RADIUS server 118. The RADIUS server receives the authentication request and determines on the basis of the user ID the system to which the terminal 14 wants to connect.

The RADIUS server transmits 210 the authentication request to the system 100 in question. The request can be transmitted through the Internet 106, for instance, by using a suitable secure connection 108. The authentication request preferably comprises the same fields as the request received by the RADIUS server, i.e. the challenge generated for the terminal, the response of the terminal to the challenge, the user ID and identification.

In the system 100, the authentication request is directed to the identification server 124 of the system. The identification server receives the authentication request and requests from the database 130 the password corresponding to the user ID in the authentication request. The database 130 can be the user register of the system, for instance. After receiving the password from the database, the identification server generates 214 a response to the challenge in the authentication request by using the password received from the database. The identification server compares the response it generated with the response in the authentication request and performs the authentication in this way. If the responses match, the identification server can approve the connection establishment of the terminal. If the responses differ, the identification server does not permit the connection.

The identification server 124 transmits 216 the result obtained from the comparison to the RADIUS server 118 over a secure connection 108. The RADIUS server transmits 218 the information to NAS 112, which either establishes a connection with the terminal 114 or interrupts the establishment of the connection depending on the response from the identification server.

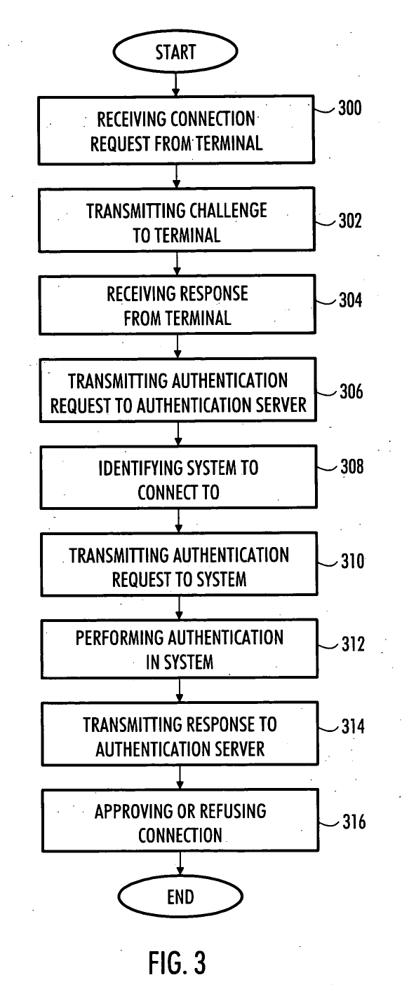

Let us yet examine an example of an embodiment by means of the flow chart in FIG. 3. In step 300, a connection request is received from a terminal in a telecommunications network. In step 302, a connection challenge is transmitted to the terminal. The terminal encrypts a response, and in step 304, a user ID, equipment ID and the encrypted response to the challenge is received from the terminal. Next, an authentication request containing the information received from the terminal is transmitted 306 to an authentication server. In step 308, the system to which the terminal wants to connect is identified. Next, the authentication server transmits 310 an authentication enquiry on the basis of the information received by it to an identification server of the system.

The identification server of the system is arranged to authenticate the terminal that transmitted the request in step 312. Next, a response is transmitted 314 to the authentication server. Finally, on the basis of the response, the establishment of a connection between the system and the terminal is approved or refused 316.

Even though the invention is described above with reference to the examples in the drawings, it is clear that the invention is not restricted to them, but can be modified in many ways within the scope of the attached claims.

1. An arrangement for authenticating terminal equipment, the arrangement comprising an authentication server that is arranged
to receive an authentication request concerning the terminal equipment establishing a connection and comprising a user ID,
to identify on the basis of the user ID the system, to which the terminal equipment is trying to connect,
to transmit the authentication request to an identification server of said system, and
the identification server of the system is arranged to authenticate the terminal equipment which transmitted the request and to send a response to the authentication server that is arranged, on the basis of the response, to either approve or refuse the establishment of a connection between the system and terminal equipment.

2. An arrangement as claimed in claim 1, wherein the authentication server is a RADIUS server.

3. An arrangement as claimed in claim 1, the arrangement further comprising a network access server that is operatively connected to the authentication server and arranged to receive connection requests from terminals.

4. An arrangement as claimed in claim 1, wherein the identification server of the system is arranged to check user identification information from its own database.

5. An arrangement as claimed in claim 1, wherein the terminal equipment is a mobile phone.

6. A method for authenticating terminal equipment establishing a connection to a system the method comprising
receiving at an authentication server an authentication request concerning the terminal equipment establishing the connection and comprising a user ID,
determining at the authentication server on the basis of the user ID the system, to which the terminal equipment is trying to connect,
transmitting from the authentication server the authentication request to the identification server of said system,
authenticating the terminal equipment sending the request in the identification server of the system, and sending a response to the authentication server,
approving or refusing, on the basis of the response, the establishment of a connection between the system and terminal.

7. A method as claimed in claim 6, wherein the identification server of the system checks the validity of the authentication request from the user register of the system.

8. A method as claimed in claim 6, the method further comprising receiving a connection request from terminal equipment in a telecommunications network,
transmitting a connection challenge to the terminal equipment,
receiving from the terminal equipment a user ID, equipment ID and an encrypted response to the challenge,
transmitting an authentication request to the authentication server, containing the information received from the terminal equipment, and
transmitting on the basis of the information received by the authentication server an authentication enquiry from the authentication server to the identification server of the system.
